(19) United States
(12) Patent Application Publication
(10) Pub. No.: US 2026/0115707 A1
(43) Pub. Date: Apr. 30, 2026

(54) ROBUST 3D-PRINTED ZINC-CLAY BASED CATALYSTS FOR SUSTAINABLE WASTEWATER TREATMENT

(71) Applicant: University of Doha for Science and Technology, Doha (QA)

(72) Inventors: Sardar ALI, Doha (QA); Mohannad ALJARRAH, Doha (QA); Hassan MAHASNEH, Doha (QA)

(21) Appl. No.: 18/927,715

(22) Filed: Oct. 25, 2024

(51) Int. Cl. B01J 37/00; B01J 23/06; B28B 3/20; B28B 11/24; B28C 3/00; B33Y 70/10; B33Y 80/00; C02F 1/32; C02F 1/70; C02F 101/30

(52) U.S. Cl. CPC B01J 37/0009; B01J 23/06; B28B 3/20; B28B 11/243; B28C 3/00; C02F 1/32; C02F 1/705; B33Y 70/10; B33Y 80/00; C02F 2101/308

(57) ABSTRACT

The present simple, cost-effective and eco-friendly method of developing highly efficient and stable clay-based 3D-printed catalysts using extrusion-based technique and applications.

The present 3D-printed catalyst formulations are highly flexible according to the required active metals. The extruded 3D-printed catalyst structure possesses high precision in structure and mechanical strength and can be utilized for a wide range of wastewater treatment processes. Additionally, the methods and 3D-printed catalysts provide sustainable and efficient waste treatment process in the presence of visible light.

### TECHNICAL FIELD

This disclosure relates generally to the development of catalysts using additive manufacturing such as 3D-printing technology. Specifically, the present disclosure relates to synthesis of Zn/Clay based photocatalysts.

### BACKGROUND

Certain organic contaminants, even at low quantities, are extremely hazardous in water resources, posing a serious health and environmental risk. Dyes are particularly concerning owing to their severe toxicity and the wide range of industrial processes that result in contaminated wastewater.

There are numerous techniques available for removing organic dyes from wastewater. Adsorption, ultrafiltration, and reverse osmosis are the three most used conventional physical techniques used to remove dyes form wastewater. Physical treatment techniques transport organic dyes from one phase to another phase rather than degrading the dyes, making them unsustainable for the environment. Furthermore, due to their stability and complicated aromatic structures, organic dyes are rarely eliminated by biological degradation and instead tend to persist in the environment.

Conversely, conventional chemical processes are costly, require significant quantities of hazardous chemicals, and may not completely oxidize the dyes. Moreover, chemical processes result in the generation of large amounts of sludge as by product that requires additional treatment.

Thus, the scientific community and government organizations have been interested in Advanced Oxidation Processes (AOPs). A photocatalyst is used in the AOPs technique to degrade the organic pollutant without being consumed in the process. Employing a photocatalyst in the AOPs has the added benefit of having the ability to degrade a variety of organic contaminants since the catalytic process produces active species that actively participate in the redox process. It is also critical to note that, in an active state, the photocatalyst can oxidize contaminants at a concentration of parts per billion (ppb).

Nevertheless, despite these benefits, recovering and/or separating the catalyst after usage is extremely challenging and can result in the loss of active sites and catalysts. This is because the AOPs need substantial volumes of expensive chemicals. The procedure is not sustainable overall due to the additional difficulty of separating the photocatalyst after it has been utilized in the process. Furthermore, typical photocatalysts are expensive since they may contain precious metals.

Accordingly, there is a need for a simple and cost-effective method to successfully construct highly active 3D printed photocatalysts that eliminate the issues associated with AOPs.

### SUMMARY

The present disclosure relates generally to the development of catalysts using additive manufacturing and/or 3D-printing technology. Particularly the present invention relates to the synthesis of Zn/Clay based photocatalysts. The present methods and 3D-printing catalysts have particular use in the case of sustainable and efficient wastewater treatment for removal of organic pollutants using photocatalytic process. The present methods and 3D-printed catalysts utilize photocatalytic degradation of methylene blue as a model reaction. However, this example is provided for exemplary purposes only and is not intended to limit the scope of the invention.

The present methods and 3D-printed catalysts are highly desirable to overcome two main challenges faced by the existing Advanced Oxidative Processes (AOPs) for wastewater treatment. Firstly, the 3D-printed catalysts have demonstrated extremely high activity with greater than about 95%, greater than 98%, and/or 100 percent efficiency for wastewater treatment particularly oxidative degradation of organic pollutants with MB degradation as model reaction. Secondly, the 3D-printed photocatalysts can easily be separated after being employed for the treatment process, which makes the overall process more efficient and sustainable. Further, the present 3D-printed photocatalysts do not include usage of expensive materials making the overall technology and process cost-effective.

In an embodiment, provided herein is a method of fabricating a 3D-printed catalyst comprising a clay and alumina matrix and dispersed transition metal nanoparticles within the clay and alumina matrix, wherein the method includes mixing clay, alumina, a transition metal powder, and water to form a paste mixture with rheological properties suitable for 3D-printing at ambient conditions; and extruding the paste mixture to form the 3D-printed catalyst. In an example, the transition metal powder includes zinc, wherein the amount of zinc is about 7 wt% of the 3D-printed catalyst, and wherein the alumina is about 3 wt% of the 3D-printed catalyst. The method can further include drying the 3D-printed catalyst at room temperature for at least 24 hours to form a first dried 3D-printed catalyst; drying the first dried 3D-printed catalyst in an oven at a temperature of at least 150° C. for three hours to form a second dried 3D-printed catalyst; and treating the second dried 3D-printed catalyst at a temperature of above at 600° C. and a cooling rate of 2° C./min at a dwell time of at least three hours.

In an embodiment, the 3D-printed catalyst comprises a cylindrical shape with woodpile structure; an outer diameter of the cylindrical shape is between about 20 mm and about 30 mm; a height of the cylindrical shape is between about 8 mm and about 12 mm; and an outer diameter of the rod is between about 0.5 mm and about 1.5 mm.

In an embodiment, the 3D-printed catalyst achieves an efficiency of greater than about 98% for methylene blue degradation in about 30 minutes or less at ambient conditions and in presence of UV-light using a tungsten filament using a batch reactor. In an embodiment, the 3D-printed catalyst possesses reusability for at least five consecutive cycles maintaining an efficiency of at least about 98%.

In an embodiment, provided herein is a method of treating methylene blue contaminated water, the method comprising contacting the contaminated water with the 3D-printed catalyst produced by the method of fabricating a 3D-printed catalyst comprising a clay and alumina matrix and dispersed transition metal nanoparticles within the clay and alumina matrix, wherein the method includes mixing clay, alumina, a transition metal powder, and water to form a paste mixture with rheological properties suitable for 3D-printing at ambient conditions; and extruding the paste mixture to form the 3D-printed catalyst, thereby degrading methylene blue within the methylene blue contaminated water.

In an embodiment, provided herein a 3D-printed catalyst produced by the method of fabricating a 3D-printed catalyst comprising a clay and alumina matrix and dispersed transition metal nanoparticles within the clay and alumina matrix, wherein the method includes mixing clay, alumina, a transition metal powder, and water to form a paste mixture with rheological properties suitable for 3D-printing at ambient conditions; and extruding the paste mixture to form the 3D-printed catalyst.

In an embodiment, provided herein is a 3D-printed catalyst, comprising a cylindrical shape with woodpile structure; an outer diameter of the cylindrical shape is between 20 mm and 30 mm; a height of the cylindrical shape is between 8 mm and 12 mm; and an outer diameter of the rod is between 0.5 mm and 1.5 mm.

### BRIEF DESCRIPTION OF THE DRAWINGS

For proper understanding of example embodiments, reference should be made to the accompanying drawings, as follows:

FIG. 1 is a schematic for testing the 3D-printed catalyst for photocatalytic reactions. FIG. 1 depicts the self-made assembly for testing the photocatalyst using degradation of methylene blue as a model reaction.

FIGS. 2A-2B are representative digital images of the 3D-printed catalyst. FIG. 2A is a front view showing the cylindrical shape of the catalyst with an outer ID of 25 mm, rod size of 1 mm and space between rods of 0.5 mm, and FIG. 2B is a side view of the cylindrical catalyst with a height of 10 mm.

FIGS. 3A-3C are representative SEM images with EDX analysis of the 3D-printed catalysts. Affirming geometry of the catalysts as shown in FIG. 1. Additionally, it also shows the porous nature of the materials. EDX analysis shows that the active ingredients (Zn as example) are homogeneously distributed over the substrate.

FIG. 4 illustrates an example of X-ray diffraction analysis results showing the presence of various species of Zn with smaller size indicating homogenous distribution and smaller particle size.

FIG. 5 illustrates N₂-adsorption and desorption analysis of the catalyst showing the mesoporous nature of the 3D-printed catalyst.

FIG. 6 illustrates UV-visible spectra of samples taken at different intervals during the degradation process depicting effectiveness of the 3D-printed catalyst for sustainable wastewater treatment process.

FIG. 7 illustrates 3D-printed catalyst % photodegradation efficiency of the Zn/Clay 3D-printed catalyst for MB removal.

FIGS. 8A-8B are a depiction of activity results of the catalyst during five consecutive cycles of photodegradation of methylene blue showing the reusability of the 3D-printed catalysts.

FIG. 9 illustrates XRD analysis results of the fresh calcined and post-run/used Zn/clay 3D-printed catalyst revealing negligible changes in the catalyst structure after being employed for the degradation process.

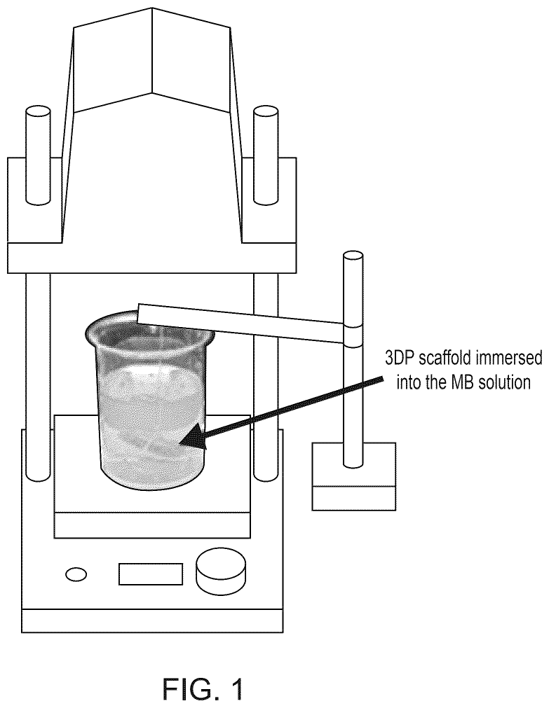

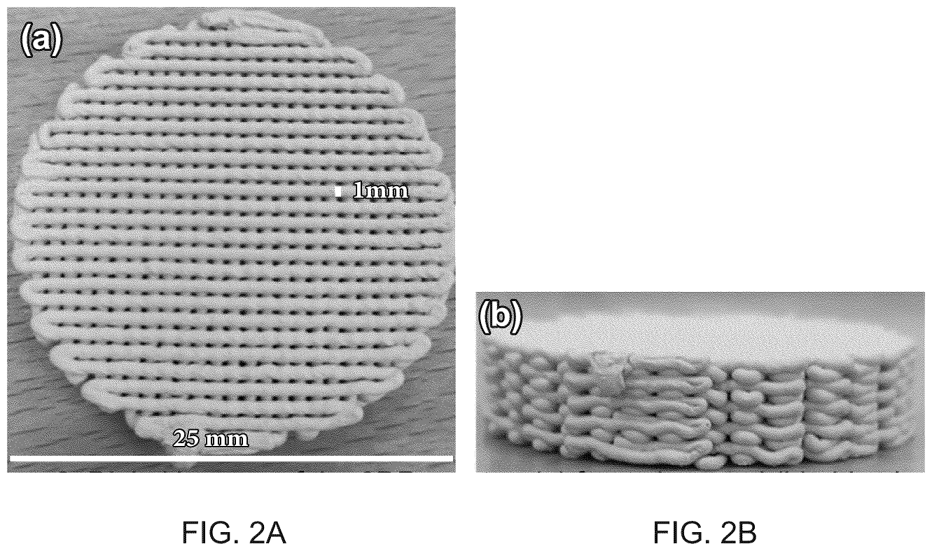

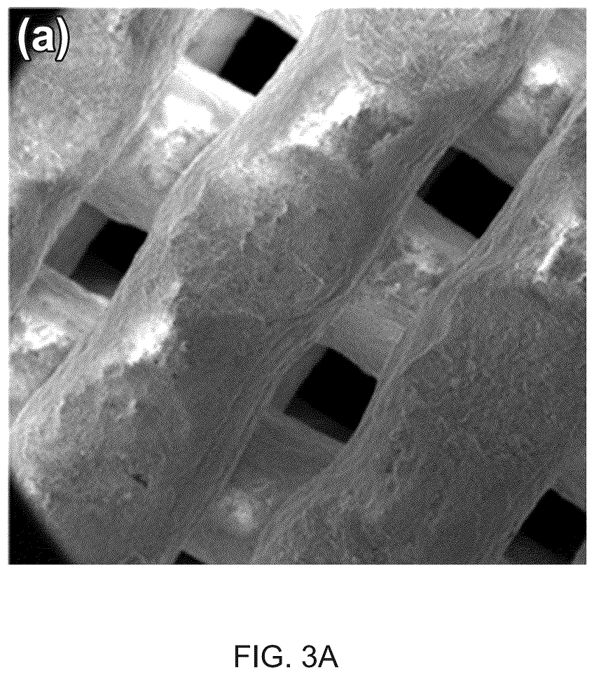

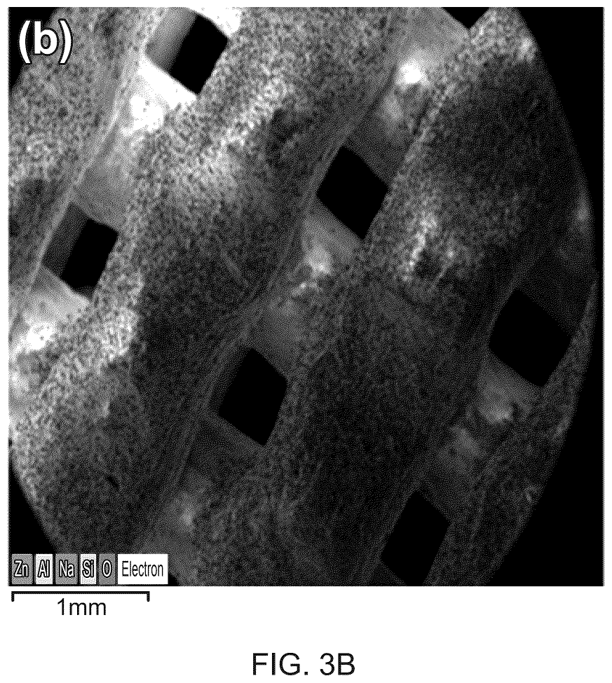

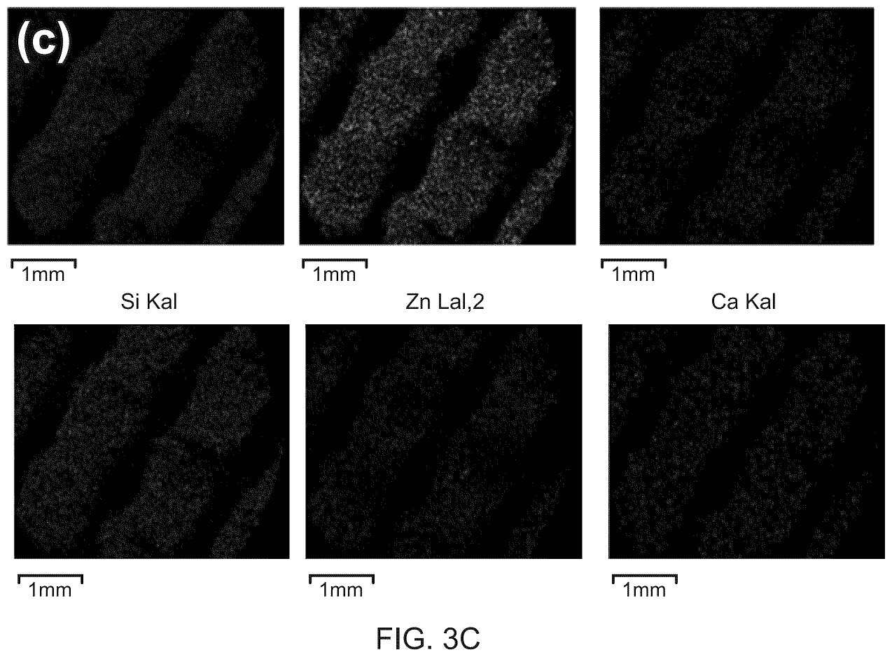

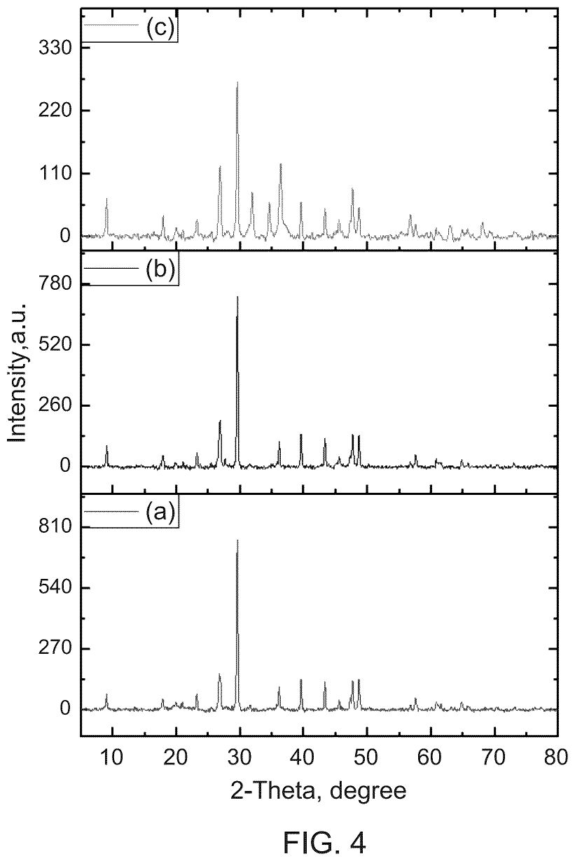

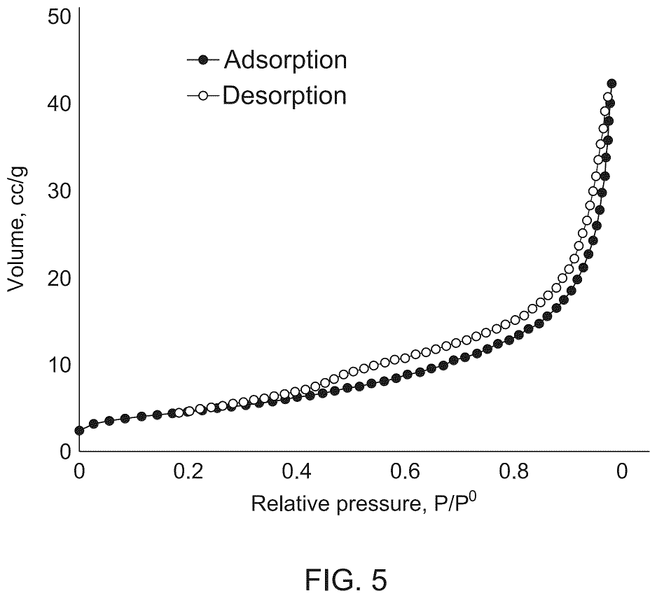

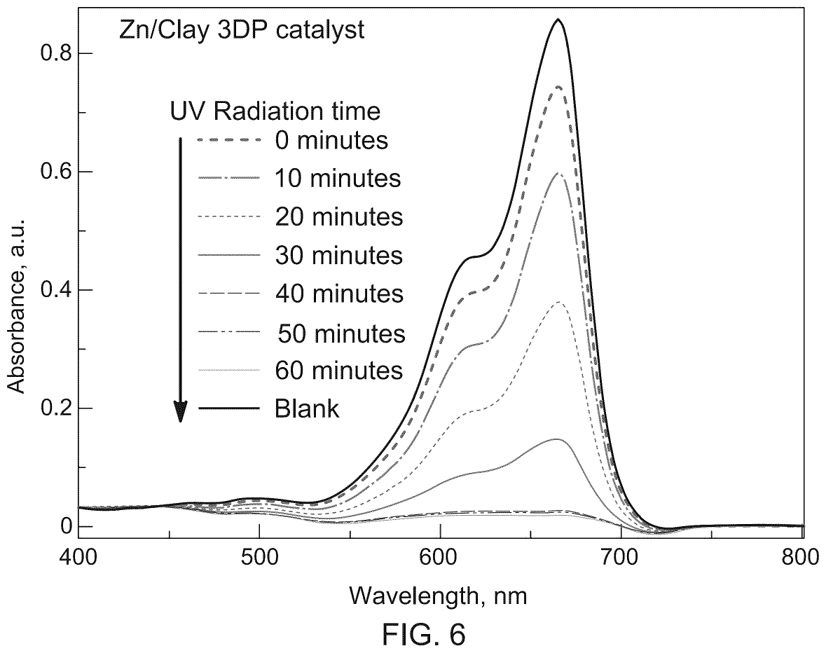

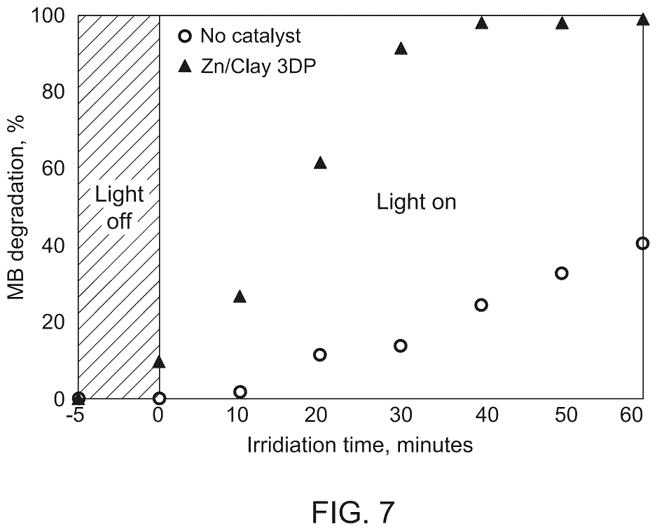

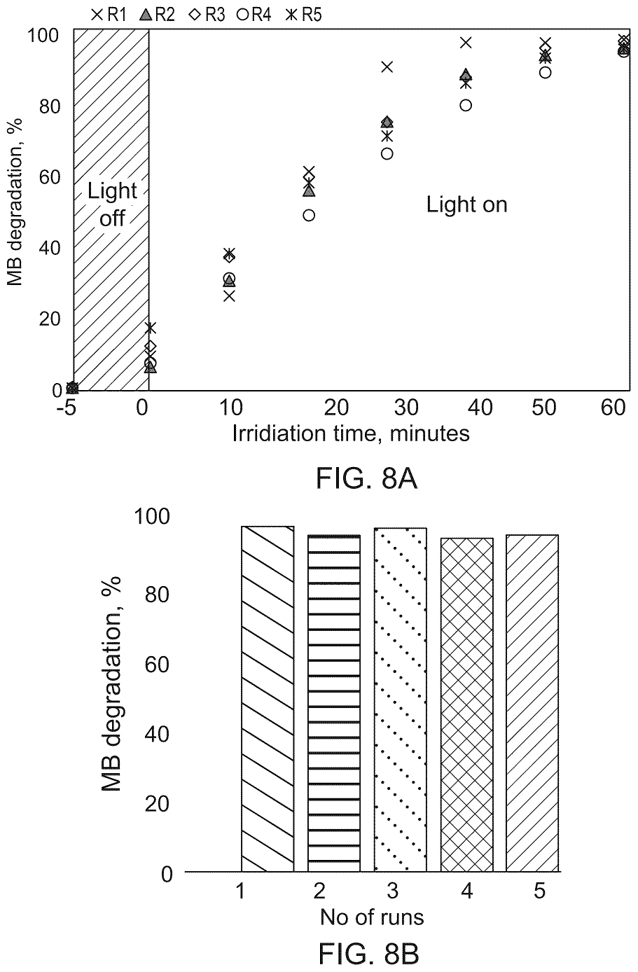

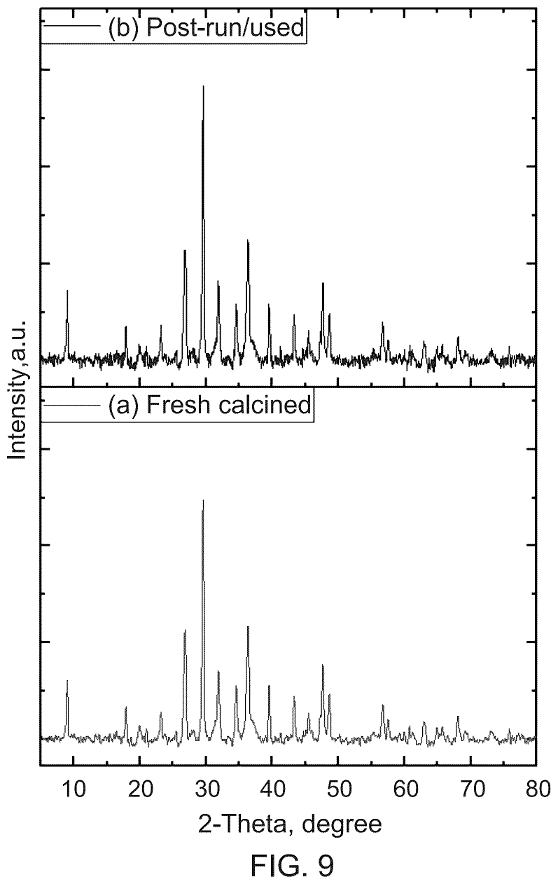

### DETAILED DESCRIPTION

The present method is a simple and cost-effective method to successfully construct highly active 3D-printed photocatalysts that eliminate the negative issues with AOPs. The present methods and 3D-printed photocatalysts are customizable for the preparation of quick and stable complex structure of 3D-printed catalysts. The 3D-printed catalyst formulations are highly flexible according to the required active metal. The obtained structure possesses high precision in structure and mechanical strength and can be utilized for a wide range of wastewater treatment processes. Additionally, the present methods and the 3D-printed photocatalysts can be used for sustainable and efficient waste treatment process in the presence of visible light.

The present 3D-printed catalysts comprise alumina and clay as backbone of the scaffold and decorated with Zn as active ingredients. In an example, the present 3D-printed catalysts consist of alumina and clay as a backbone of the scaffold and intercalated with Zn as active ingredients.

In an embodiment, the method of fabricating a 3D-printed catalyst comprises a clay and alumina matrix and dispersed transition metal nanoparticles within the clay and alumina matrix, the method comprising mixing clay, alumina, a transition metal powder, and water to form a paste mixture with rheological properties suitable for 3D-printing at ambient conditions; and extruding the paste mixture to form the 3D-printed catalyst.

The method can include drying the 3D-printed catalyst at room temperature for at least 24 hours to form a first dried 3D-printed catalyst; drying the first dried 3D-printed catalyst in an oven at a temperature of at least 150° C. for three hours to form a second dried 3D-printed catalyst; and treating the second dried 3D-printed catalyst at a temperature of above at 600° C. and a cooling rate of 2° C./min at a dwell time of at least three hours.

In an example, the transition metal powder includes zinc, wherein the amount of zinc is about 5-10 wt% of the 3D-printed catalyst, and wherein the alumina is about 1-5 wt% of the 3D-printed catalyst. For example, the transition metal powder includes zinc, wherein the amount of zinc is about 7 wt% of the 3D-printed catalyst, and wherein the alumina is about 3 wt% of the 3D-printed catalyst.

The present 3D-printed photocatalysts can be produced by extrusion based direct ink writing technique. The present 3D-printed catalysts can be cylindrical in shape with an outer diameter of between about 20 mm and about 30 mm, about 22 mm to about 28 mm, or about 24 mm to about 26 mm (e.g., 20 mm, 23 mm, 25 mm, 27 mm, or 30 mm), a length (height) between about 5 mm and about 15 mm, between about 8 mm and about 12 mm, or about 9 mm and about 11 mm (e.g., 5 mm, 10 mm, or 15 mm), a rod diameter between about 0.5 mm and about 2 mm, about 0.8 mm and about 1.5 mm, or about 0.9 mm to about 1.1 mm (e.g., 0.5 mm, 1 mm, or 1.5 mm), and with an internal spacing between about 0.1 mm to about 1 mm (e.g., 0.2 mm, 0.5 mm, 0.7 mm, or 0.9 mm).

The present 3D-printed catalysts have demonstrated high activity and stability for sustainable wastewater treatment with greater than about 95%, greater than about 98%, or 100 percent efficiency for photocatalytic degradation of methylene blue, which was achieved in only about 30 minutes.

In an example, the 3D-printed catalyst does not require any regeneration steps between tested cycles during reusability. The 3D-printed catalyst may have no changes in properties after being employed for a wastewater treatment process. Further, the method may not require or need any additional post-run separation required.

In an aspect, provided herein is a method of treating methylene blue contaminated water, the method comprising contacting the contaminated water with the 3D-printed catalyst produced by the method disclosed herein thereby degrading methylene blue within the methylene blue contaminated water.

### EXAMPLES

50 grams of white clay was combined with about 1 grams of alumina, followed by thoroughly mixing the mixture using a mechanical stirrer to make a homogeneous mixture. About 2 grams of Zn powder (synthesized using precipitation deposition method) was then added and mechanically stirred again to form a homogeneous mixture. About 5 grams of water was added to the homogeneous mixture to form a paste mixture with the required rheological properties for printing. The paste mixture was loaded into a syringe attached by a nozzle with a diameter of about 1 mm. The printer was equipped with a robotic deposition system to create the required structure. The robotic motion was controlled by printing software. The cylindrical woodpile structure possesses the dimensions of 25 mm diameter, 10 mm height, rod size 1 mm, wherein the space between rods were 0.5 mm. The printing process is performed at ambient conditions. Finally, the woodpile structure was dried at room temperature for one day and subsequently sintered at 600° C. for 3 hours in air in a conventional furnace at a heating rate of 2° C. min⁻1.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

We claim:

1. A method of fabricating a 3D-printed catalyst comprising a clay and alumina matrix and dispersed transition metal nanoparticles within the clay and alumina matrix, the method comprising:
mixing clay, alumina, a transition metal powder, and water to form a paste mixture with rheological properties suitable for 3D-printing at ambient conditions; and
extruding the paste mixture to form the 3D-printed catalyst.

2. The method of claim 1, wherein the transition metal powder includes zinc, wherein the amount of zinc is about 7 wt% of the 3D-printed catalyst, and wherein the alumina is about 3 wt% of the 3D-printed catalyst.

3. The method of claim 1, further comprising drying the 3D-printed catalyst at room temperature for at least 24 hours to form a first dried 3D-printed catalyst;
drying the first dried 3D-printed catalyst in an oven at a temperature of at least 150° C. for three hours to form a second dried 3D-printed catalyst; and
treating the second dried 3D-printed catalyst at a temperature of above at 600° C. at a dwell time of at least three hours.

4. The method of claim 1, wherein the 3D-printed catalyst comprises
a cylindrical shape with woodpile structure;
an outer diameter of the cylindrical shape is between about 20 mm and about 30 mm;
a height of the cylindrical shape is between about 8 mm and about 12 mm; and
an outer diameter of the rod is between about 0.5 mm and about 1.5 mm.

5. The method of claim 1, wherein the 3D-printed catalyst comprises
a cylindrical shape with woodpile structure;
an outer diameter of the cylinder is about 25 mm;
a height of the cylinder is about 10 mm; and
an outer diameter of the rod is about 1 mm.

6. The method of claim 1, wherein the 3D-printed catalyst achieves an efficiency of greater than about 98% for methylene blue degradation in about 30 minutes or less at ambient conditions and in presence of UV-light using a tungsten filament using a batch reactor.

7. The method of claim 1, wherein the 3D-printed catalyst possesses reusability for at least five consecutive cycles maintaining an efficiency of at least about 98%.

8. The method of claim 1, wherein the 3D-printed catalyst does not require any regeneration steps between tested cycles during reusability.

9. The method of claim 1, wherein the 3D-printed catalyst has no changes in properties after being employed for a wastewater treatment process.

10. The method of claim 1, wherein no additional post-run separation is required.

11. A method of treating methylene blue contaminated water, the method comprising contacting the contaminated water with the 3D-printed catalyst produced by the method of claim 1 thereby degrading methylene blue within the methylene blue contaminated water.

12. A 3D-printed catalyst produced by the method of claim 1.

13. A 3D-printed catalyst, comprising:
a cylindrical shape with woodpile structure;
an outer diameter of the cylindrical shape is between about 20 mm and about 30 mm;
a height of the cylindrical shape is between about 8 mm and about 12 mm; and
an outer diameter of the rod is between about 0.5 mm and about 1.5 mm.

14. The 3D-printed catalyst of claim 13, wherein
the cylindrical shape with woodpile structure;
the outer diameter of the cylinder is about 25 mm;
the height of the cylinder is about 10 mm; and
the outer diameter of the rod is about 1 mm.
